(19) United States
(12) Patent Application Publication
(10) Pub. No.: US 2023/0039778 A1
(43) Pub. Date: Feb. 9, 2023

(54) PASSIVE PHASE SEPARATOR AT A HEAT EXCHANGER OUTPUT

(71) Applicant: Hamilton Sundstrand Corporation, Charlotte, NC (US)

(72) Inventor: John C. Mann, Glastonbury, CT (US)

(21) Appl. No.: 17/407,825

(22) Filed: Aug. 20, 2021

Related U.S. Application Data
(60) Provisional application No. 63/229,800, filed on Aug. 5, 2021.

(51) Int. Cl. B01D 19/00

(52) U.S. Cl. CPC B01D 19/0031

(57) ABSTRACT

A passive phase separator includes an inlet to receive two-phase flow into an inner conduit and an outer conduit. An annulus is formed between the inner conduit and the outer conduit. A hydrophobic screen separation device prohibits a flow of liquid from the two-phase flow into the annulus while allowing a flow of gas from the two-phase flow into the annulus, and a gas flow outlet releases the flow of gas from the annulus.

### CROSS-REFERENCE TO RELATED APPLICATIONS

This application claims the benefit of U.S. Provisional Application No. 63/229,800 filed Aug. 5, 2021, the disclosure of which is incorporated herein by reference in its entirety.

### BACKGROUND

Exemplary embodiments pertain to the art of heat exchangers and, in particular, to a passive phase separator at an output of a heat exchanger.

In certain environments, a heat exchanger may be used to revitalize air through condensing, cooling, filtering, and humidifying. In a zero-gravity environment such as the space environment, condensation of water and its separation from the remaining gaseous phase presents a technical challenge. Any water droplets remaining in the gas (e.g., cabin air) may impede the function of various equipment (e.g., soak the filter) or coalesce to form a potential hazard (e.g., within a space vehicle, life support suit, space station, habitat).

### BRIEF DESCRIPTION

In one embodiment, a passive phase separator includes an inlet to receive two-phase flow into an inner conduit and an outer conduit. An annulus is formed between the inner conduit and the outer conduit. A hydrophobic screen separation device prohibits a flow of liquid from the two-phase flow into the annulus while allowing a flow of gas from the two-phase flow into the annulus, and a gas flow outlet releases the flow of gas from the annulus.

Additionally or alternatively, the two-phase flow in the inner conduit is blocked from the air flow outlet except through the hydrophobic screen separation device, the flow of liquid is a flow of water, and the flow of gas is a flow of air.

Additionally or alternatively, the hydrophobic screen separation device includes a hydrophobic screen that forms a portion of the inner conduit, and the hydrophobic screen repels the flow of liquid and facilitate the flow of gas through the hydrophobic screen into the annulus.

Additionally or alternatively, the hydrophobic screen separation device includes a screen support frame to provide structural support to hold the hydrophobic screen in a cylindrical configuration.

Additionally or alternatively, the passive phase separator also includes a liquid capture device to capture the flow of liquid from the two-phase flow.

Additionally or alternatively, the liquid capture device includes a hydrophilic membrane.

Additionally or alternatively, the gas flow outlet is above the hydrophobic screen separation device relative to a direction of the two-phase flow.

Additionally or alternatively, a direction of the flow of gas in the annulus is opposite the direction of the two-phase flow within the inner conduit.

Additionally or alternatively, the gas flow outlet is below the hydrophobic screen separation device relative to a direction of the two-phase flow.

Additionally or alternatively, a direction of the flow of gas in the annulus is the direction of the two-phase flow within the inner conduit.

In another embodiment, a method of fabricating a passive phase separator includes forming an inlet to receive two-phase flow into an inner conduit and arranging an outer conduit to form an annulus between the inner conduit and the outer conduit. The method also includes positioning a hydrophobic screen separation device to prohibit a flow of liquid from the two-phase flow into the annulus while allowing a flow of gas from the two-phase flow into the annulus. A gas flow outlet is arranged to release the flow of gas from the annulus.

Additionally or alternatively, the method also includes arranging the inner conduit to block the two-phase flow in the inner conduit from the gas flow outlet except through the hydrophobic screen separation device. The flow of liquid is a flow of water and the flow of gas is a flow of air.

Additionally or alternatively, the method also includes forming the hydrophobic screen separation device to include a hydrophobic screen that forms a portion of the inner conduit, wherein the hydrophobic screen is configured to repel the flow of liquid and facilitate the flow of gas through the hydrophobic screen into the annulus.

Additionally or alternatively, the forming the hydrophobic screen separation device includes configuring a screen support frame to provide structural support to hold the hydrophobic screen in a cylindrical configuration.

Additionally or alternatively, the method also includes arranging a liquid capture device to capture the flow of liquid from the two-phase flow.

Additionally or alternatively, the liquid capture device includes a hydrophilic membrane.

Additionally or alternatively, the method also includes disposing the gas flow outlet above the hydrophobic screen separation device relative to a direction of the two-phase flow.

Additionally or alternatively, a direction of the flow of gas in the annulus is opposite the direction of the two-phase flow within the inner conduit.

Additionally or alternatively, the method also includes disposing the gas flow outlet below the hydrophobic screen separation device relative to a direction of the two-phase flow.

Additionally or alternatively, a direction of the flow of gas in the annulus is the direction of the two-phase flow within the inner conduit.

### BRIEF DESCRIPTION OF THE DRAWINGS

The following descriptions should not be considered limiting in any way. With reference to the accompanying drawings, like elements are numbered alike:

FIG. 1 is a cross-sectional view of a passive phase separator according to an exemplary embodiment;

FIG. 2 is an additional view cross-sectional view of the passive phase separator shown in FIG. 1;

FIG. 3 is an isometric view of a hydrophobic screen separation device of a passive phase separator according to one or more embodiments;

FIG. 4 is a cross-sectional view of the hydrophobic screen separation device of a passive phase separator shown in FIG. 3; and

FIG. 5 is a cross-sectional view of a passive phase separator according to an exemplary embodiment.

### DETAILED DESCRIPTION

A detailed description of one or more embodiments of the disclosed apparatus and method are presented herein by way of exemplification and not limitation with reference to the Figures.

As previously noted, a heat exchanger may be used to revitalize breathable air in certain environments. As also noted, removing all the water droplets from the heat exchanger before redirecting the air for use in life support may avoid various issues, especially in a zero gravity space environment. Embodiments of the systems and methods detailed herein relate to a passive phase separator at a heat exchanger output. The two phases (i.e., water and air) flow from a condensing heat exchanger to the passive phase separator. As a result of the phase separation, air is allowed to flow to a life support environment (e.g., space suit, space vehicle, habitat) while water is separated and retained for reuse. The passive phase separator according to one or more embodiments may be part of or separate from the heat exchanger system and acts on two-phase flow resulting from the heat exchange process.

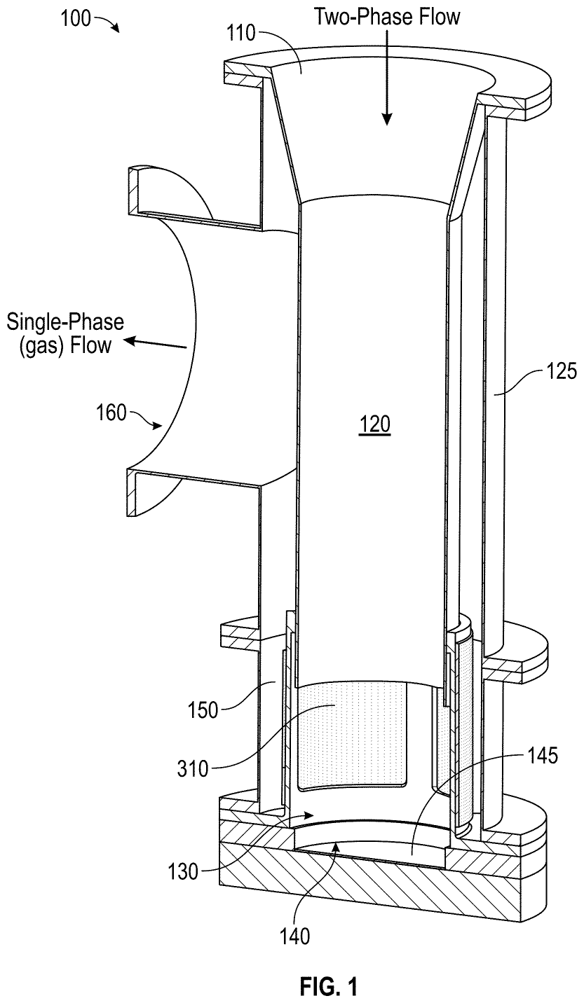

FIG. 1 is a cross-sectional view of a passive phase separator 100 according to an exemplary embodiment. An inlet 110 for a two-phase flow leads into an inner conduit 120. The two-phase flow includes a mix of gas (e.g., air) and liquid (e.g., water). A portion of this inner conduit 120 is made up of a hydrophobic screen 310 of a hydrophobic screen separation device 130. The liquid in the two-phase flow may be water-based or water and is repelled by the hydrophobic screen 310. As a result, the liquid does not go through the hydrophobic screen 310 into the annulus 150 that is formed between the inner conduit 120 and an outer conduit 125. Instead, the liquid is captured by a liquid capture device 140. The liquid capture device 140 may be a rotary separator or other known device and may include a hydrophilic membrane 145 that attracts the water that is or is in the liquid. Capturing the liquid facilitates reusing it as needed.

Unlike the liquid in the two-phase flow, the gas (e.g., air) in the two-phase flow does traverse the hydrophobic screen 310 to reach the annulus 150. This gas then exits the passive phase separator 100 via a gas flow outlet 160. The inner annulus 120 blocks passage of the two-phase flow to the air flow outlet 160. That is, aside from the hydrophobic screen 310, the inner annulus 120 does not include any additional opening into the annulus 150 that leads to the gas flow outlet 160 of the outer conduit 125. Thus, none of the liquid in the two-phase flow can reach the gas flow outlet 160. The gas flow outlet 160 may vent the gas (e.g., air) as part of a life support system.

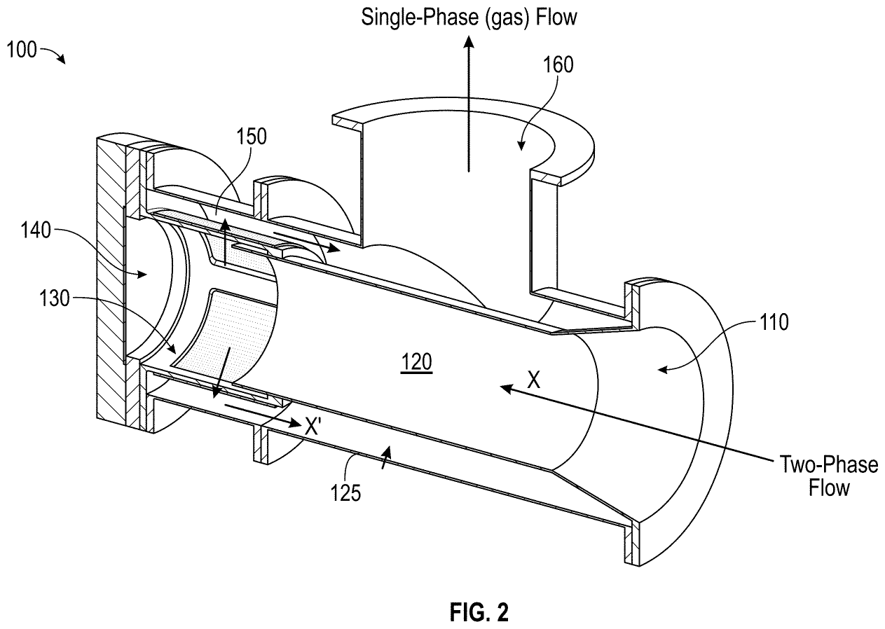

FIG. 2 is an additional view cross-sectional view of the passive phase separator 100 shown in FIG. 1. The annulus 150 between the inner conduit 120 and the outer conduit 125 is shown more clearly in FIG. 2. The arrows indicate the paths that gas in the two-phase flow may take to reach the gas flow outlet 160 of the outer conduit 125. As shown in FIGS. 1 and 2, the hydrophobic screen separation device 130 is below (downstream of) the location of the gas flow outlet 160 with respect to the indicated direction x of the two-phase flow. Thus, as the arrows indicate, the gas in the annulus 150 flows (upstream, relative to the two-phase flow direction x) in a direction x′ that is opposite the (downstream) two-phase flow direction x.

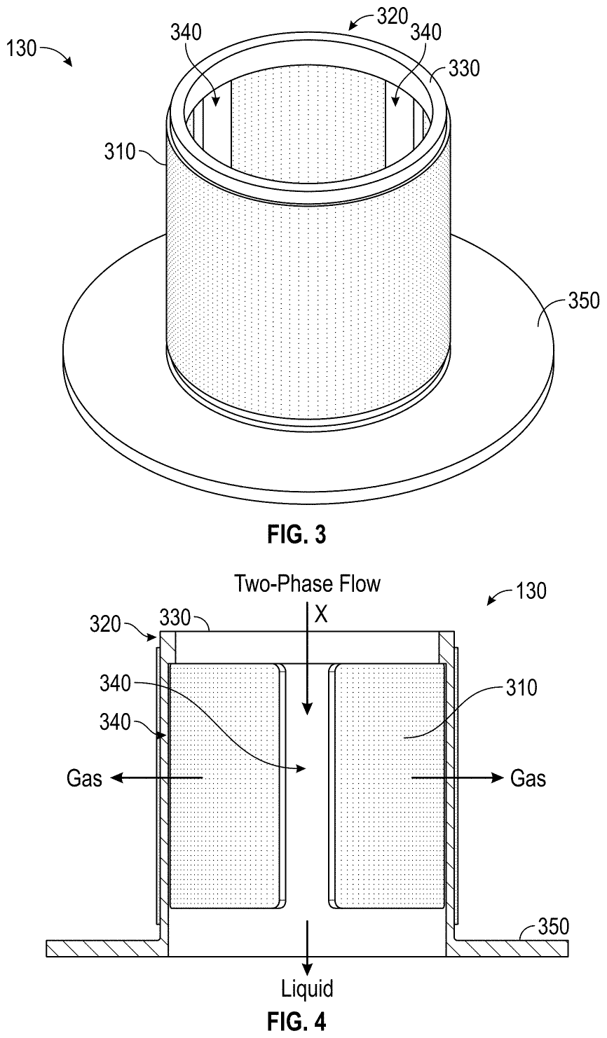

FIG. 3 is an isometric view of a hydrophobic screen separation device 130 of a passive phase separator 100 according to one or more embodiments. As indicated, the hydrophobic screen 310 is structurally supported by a screen support frame 320. The screen support frame 320 includes a ring 330 and support columns 340. The hydrophobic screen 310 forms a cylindrical shape based on the shape of the screen support frame 320 and, specifically, the ring 330. However, other shapes that match a shape of the inner conduit 120 are possible. That is, the shape of the hydrophobic screen 310 must be such that it forms a portion of the inner conduit 120 and does not provide any openings between the inner conduit 120 and the annulus 150, except via the hydrophobic screen 310. The screen support frame 320 is held by an integral mounting flange 350 according to the exemplary embodiment shown in FIG. 3.

FIG. 4 is a cross-sectional view of a hydrophobic screen separation device 130 of a passive phase separator 100 according to one or more embodiments. The cross-sectional view exposes one of the support columns 340 and results from cutting through two others. As the view in FIG. 4 clarifies, only the hydrophobic screen 310 separates the inner conduit 120 and outer conduit 125 between the support columns 340. When the two-phase flow encounters the hydrophobic screen 310, the liquid in the two-phase flow (e.g., water, water-based) cannot pass through the hydrophobic screen 310. The hydrophobic screen 310 may include a hydrophobic coating on a screen structure. The hydrophobic coating may be any known hydrophobic material such as a nano-composite (e.g., manganese oxide polystyrene) or fluoropolymer coating, for example. The screen structure, as well as the screen support frame 320 and integral mounting flange 350, may be stainless steel (e.g., 316 stainless steel) or a nickel-based alloy such as nickel-chromium alloy (e.g., Inconel) or nickel-copper alloy (e.g., Monel), for example. The gas in the two-phase flow (e.g., air) can pass through the hydrophobic screen 310 and exit through the gas flow outlet 160, as indicated in FIG. 2, for example.

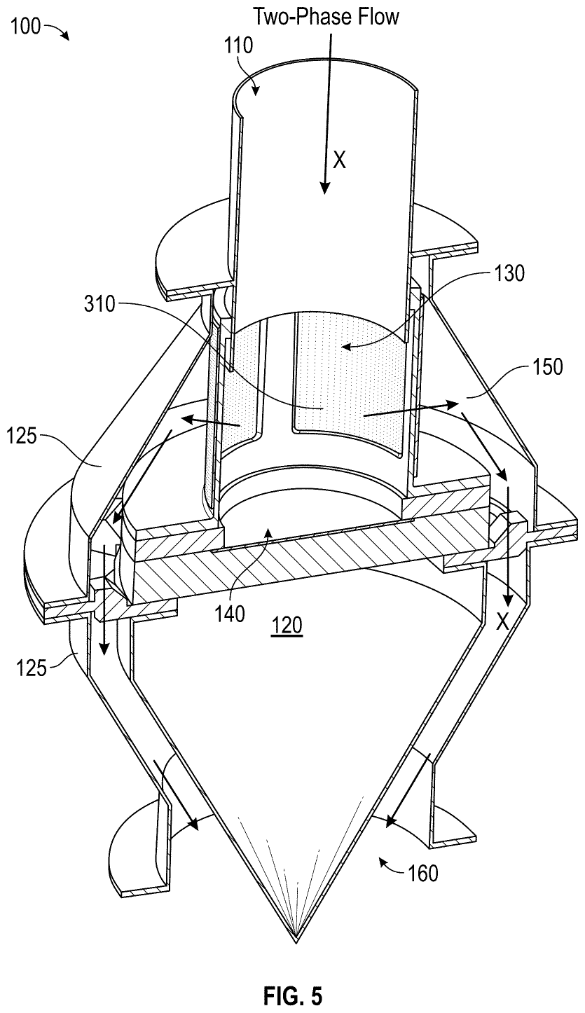

FIG. 5 is a cross-sectional view of a passive phase separator 100 according to an exemplary embodiment. As the exemplary passive phase separator 100 of FIG. 5 indicates, the inner conduit 120 and outer conduit 125 need not be only cylindrical in shape. In addition, unlike the exemplary arrangement shown in FIGS. 1 and 2, the hydrophobic screen separation device 130 is above (upstream of) the gas flow outlet 160 relative to the direction x of the two-phase flow. Thus, the gas in the two-phase flow, flowing in the direction x, goes through the hydrophobic screen 310 into the annulus 150 and continues in the direction x to the gas flow outlet 160.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A passive phase separator comprising:
an inlet configured to receive two-phase flow into an inner conduit;
an outer conduit, wherein an annulus is formed between the inner conduit and the outer conduit;
a hydrophobic screen separation device configured to prohibit a flow of liquid from the two-phase flow into the annulus while allowing a flow of gas from the two-phase flow into the annulus; and
a gas flow outlet configured to release the flow of gas from the annulus.

2. The passive phase separator according to claim 1, wherein the two-phase flow in the inner conduit is blocked from the air flow outlet except through the hydrophobic screen separation device, the flow of liquid is a flow of water, and the flow of gas is a flow of air.

3. The passive phase separator according to claim 1, wherein the hydrophobic screen separation device includes a hydrophobic screen that forms a portion of the inner conduit, and the hydrophobic screen is configured to repel the flow of liquid and facilitate the flow of gas through the hydrophobic screen into the annulus.

4. The passive phase separator according to claim 3, wherein the hydrophobic screen separation device includes a screen support frame configured to provide structural support to hold the hydrophobic screen in a cylindrical configuration.

5. The passive phase separator according to claim 1, further comprising a liquid capture device configured to capture the flow of liquid from the two-phase flow.

6. The passive phase separator according to claim 5, wherein the liquid capture device includes a hydrophilic membrane.

7. The passive phase separator according to claim 1, wherein the gas flow outlet is above the hydrophobic screen separation device relative to a direction of the two-phase flow.

8. The passive phase separator according to claim 7, wherein a direction of the flow of gas in the annulus is opposite the direction of the two-phase flow within the inner conduit.

9. The passive phase separator according to claim 1, wherein the gas flow outlet is below the hydrophobic screen separation device relative to a direction of the two-phase flow.

10. The passive phase separator according to claim 9, wherein a direction of the flow of gas in the annulus is the direction of the two-phase flow within the inner conduit.

11. A method of fabricating a passive phase separator, the method comprising:
forming an inlet to receive two-phase flow into an inner conduit;
arranging an outer conduit to form an annulus between the inner conduit and the outer conduit;
positioning a hydrophobic screen separation device to prohibit a flow of liquid from the two-phase flow into the annulus while allowing a flow of gas from the two-phase flow into the annulus; and
arranging a gas flow outlet to release the flow of gas from the annulus.

12. The method according to claim 11, further comprising arranging the inner conduit to block the two-phase flow in the inner conduit from the gas flow outlet except through the hydrophobic screen separation device, wherein the flow of liquid is a flow of water and the flow of gas is a flow of air.

13. The method according to claim 11, further comprising forming the hydrophobic screen separation device to include a hydrophobic screen that forms a portion of the inner conduit, wherein the hydrophobic screen is configured to repel the flow of liquid and facilitate the flow of gas through the hydrophobic screen into the annulus.

14. The method according to claim 13, wherein the forming the hydrophobic screen separation device includes configuring a screen support frame to provide structural support to hold the hydrophobic screen in a cylindrical configuration.

15. The method according to claim 11, further comprising arranging a liquid capture device to capture the flow of liquid from the two-phase flow.

16. The method according to claim 15, wherein the liquid capture device includes a hydrophilic membrane.

17. The method according to claim 11, further comprising disposing the gas flow outlet above the hydrophobic screen separation device relative to a direction of the two-phase flow.

18. The method according to claim 17, wherein a direction of the flow of gas in the annulus is opposite the direction of the two-phase flow within the inner conduit.

19. The method according to claim 11, further comprising disposing the gas flow outlet below the hydrophobic screen separation device relative to a direction of the two-phase flow.

20. The method according to claim 19, wherein a direction of the flow of gas in the annulus is the direction of the two-phase flow within the inner conduit.
